(19) United States
(12) Patent Application Publication
(10) Pub. No.: US 2016/0249190 A1
(43) Pub. Date: Aug. 25, 2016

(54) APPARATUS AND METHOD FOR UNIFYING MULTIPLE USER ACCOUNTS ON SOCIAL-MEDIA APPLICATIONS

(71) Applicant: AT&T Intellectual Property I, L.P., Atlanta, GA (US)

(72) Inventors: Venson Shaw, Kirkland, WA (US); Jin He, Fremont, CA (US)

(21) Appl. No.: 14/627,994

(22) Filed: Feb. 20, 2015

(51) Int. Cl. H04W 4/20; H04L 29/08

(52) U.S. Cl. CPC H04W 4/206; H04L 67/10

(57) ABSTRACT

Methods, computer-readable media and apparatuses for unifying a plurality of user accounts on different social media applications are disclosed. A processor of a mobile endpoint device detects a collection trigger, connects the mobile endpoint device to a plurality of different social media applications, collects a content from one of the plurality of different social media applications of a user based upon the collection trigger, connects the mobile endpoint device to a server that is located remotely from the mobile endpoint device, and sends the content to the server, wherein the server is for providing the content to a connection of the user in at least one of the different social media applications.

The present disclosure relates generally to communication networks and, more particularly, to an apparatus, method and a computer-readable medium for unifying a plurality of user accounts on different social media applications.

### BACKGROUND

Social media is experiencing explosive growth around the world on an ever-increasing wide range of mobile devices. Social media will likely become the most vital mobile Internet application for many years to come.

Currently, many social media applications are available to users. Users may register for accounts with a plurality of different social media applications and have different connections and friends on each one of the social media applications. In other words, social media is very fragmented.

As a result, to share content from one social media application to another social media application, the user must separately access each application and manually transfer the content. This may become cumbersome for a large number of social media application accounts.

### SUMMARY

In one example, the present disclosure discloses a method, computer-readable medium, and apparatus for unifying a plurality of user accounts on different social media applications. For example, the method may include a processor of a mobile endpoint device that detects a collection trigger, connects the mobile endpoint device to a plurality of different social media applications, collects a content from one of the plurality of different social media applications of a user based upon the collection trigger, connects the mobile endpoint device to a server that is located remotely from the mobile endpoint device, and sends the content to the server, wherein the server is for providing the content to a connection of the user in at least one of the different social media applications.

### BRIEF DESCRIPTION OF THE DRAWINGS

The teaching of the present disclosure can be readily understood by considering the following detailed description in conjunction with the accompanying drawings, in which:

FIG. 1 illustrates an example network related to the present disclosure;

FIG. 2 illustrates examples of social media applications that provide content;

FIG. 3 illustrates a flowchart of an example method for unifying a plurality of user accounts on different social media applications;

FIG. 4 illustrates a flowchart of another example method for unifying a plurality of user accounts on different social media applications; and

FIG. 5 illustrates a high-level block diagram of a computer suitable for use in performing the functions described herein.

To facilitate understanding, identical reference numerals have been used, where possible, to designate identical elements that are common to the figures.

### DETAILED DESCRIPTION

The present disclosure broadly discloses methods, computer-readable media and devices for unifying a plurality of user accounts on different social media applications. As discussed above, many social media applications are available to users. Users may register for accounts with a plurality of different social media applications and have different connections and friends on each one of the social media applications. In other words, social media is very fragmented.

As a result, to share content from one social media application to another social media application, the user must separately access each application and manually transfer the content. This may become cumbersome for a large number of social media application accounts and a large amount of content.

In one example, the present disclosure provides an apparatus and method for unifying multiple user accounts on different social media applications. For example, the multiple different social media applications of the user may be virtualized into a single account on a server in a cloud service of a communication network service provider that allows any connection of any social media application to access content provided by the server.

For example, currently a friend on a user's Facebook® account may not be a connection of the user on the user's Twitter® account or on the user's Instagram® account and so on. The user may have a follower on the user's Instagram® account that is not a friend on the user's Facebook® account, and so forth. The user may post videos on his or her Facebook® account that are not shared on the user's Instagram® account and vice versa.

However, with embodiments of the present disclosure, the user may collect content from all of the user's different social media applications and send them to a server in a cloud service. The content may then be accessible by any connection (e.g., a friend, a follower, etc) of the user's accounts on different social media applications from the server. As a result, the content appears to the user's connections as a unified social media application of the plurality of different social media applications of the user.

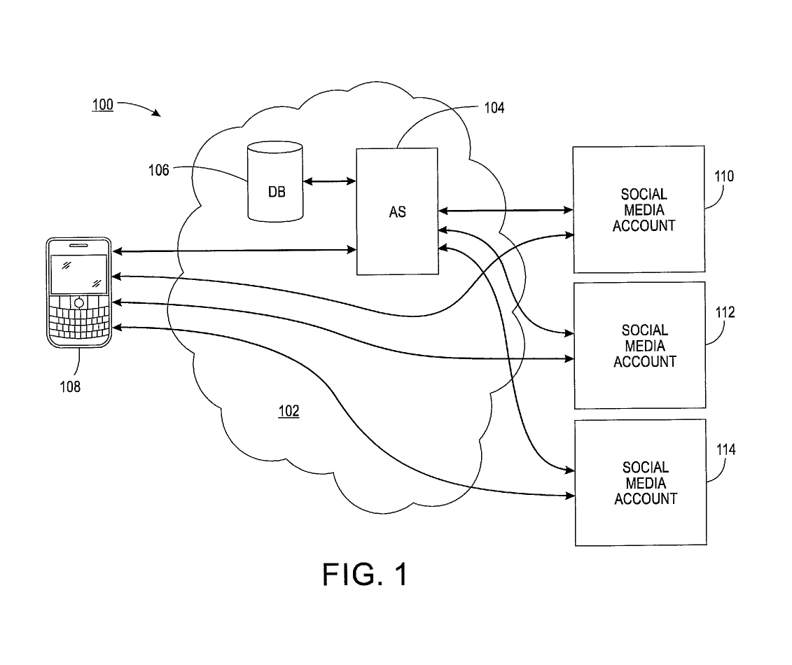

To aid in understanding the present disclosure, FIG. 1 illustrates a block diagram depicting one example of a communications network 100 suitable for performing or enabling the steps, functions, operations and/or features described herein. The overall communication network 100 may include any number of interconnected networks which may use the same or different communication technologies, such as a traditional circuit switched network (e.g., a public switched telephone network (PSTN)) or a packet network such as an Internet Protocol (IP) network (e.g., an IP Multimedia Subsystem (IMS) network), an asynchronous transfer mode (ATM) network, a wireless network, a cellular network (e.g., 2G, 3G, and the like), a long term evolution (LTE) network, and so forth. It should be noted that an IP network is broadly defined as a network that uses Internet Protocol to exchange data packets.

FIG. 1 illustrates an example communications network 100. In one embodiment, the communications network 100 may include an Internet Protocol (IP) network 102. The IP network 102 may include an application server (AS) 104 and a database (DB) 106. Although only a single AS 104 and a single DB 106 is illustrated in FIG. 1, it should be noted that any number of application servers and databases may be deployed.

For example, the AS 104 may be part of a server farm that provides cloud services to a user. For example, a service provider of the communication network 100 may also provide a cloud service where data, media content, and the like, can be stored on the DB 106.

It should be noted that the IP network 102 has been simplified for ease of explanation. The IP network 102 may include additional network elements that are not shown, such as for example, a gateway, a firewall, a call control element, one or more access networks, and the like. In one embodiment, the IP network 102 may be a cellular communication network (e.g., a 3G, 4G, LTE, and the like) or includes a cellular communication network as an access network.

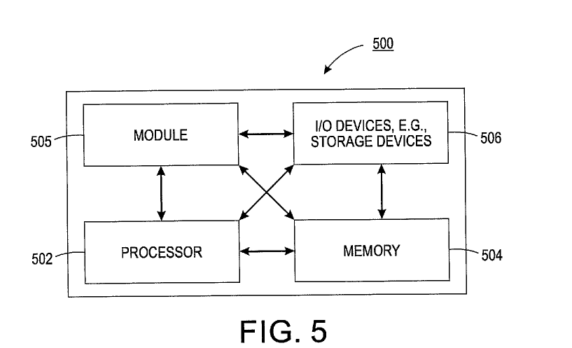

In one embodiment, the communications network 100 may include a mobile endpoint device 108 and a plurality of different social media applications 110, 112 and 114. In one embodiment, the mobile endpoint device 108 may be any type of device communicating with the IP network 102 over a wired or wireless connection. For example, the mobile endpoint device 108 may be a cellular telephone, a smartphone, a tablet computer, a laptop computer, a desktop computer, and the like. In one embodiment, the mobile endpoint device 108 may include a processor and a memory similar to the computer illustrated in FIG. 5 and described below.

In one embodiment, the social media applications 110, 112 and 114 (e.g., Facebook®, Instagram®, Twitter®, Yelp®, LinkedIn®, WhatApp®, Google Circle®, and the like) may be deployed as servers or computers having a processor and memory similar to the computer illustrated in FIG. 5 and described below. In one embodiment, the social media applications 110, 112 and 114 may be a website that can be reached by a web browser application executing on the mobile endpoint device 108 or an application that is executed as a stand-alone program on the mobile endpoint device 108.

In one embodiment, the social media applications 110, 112 and 114 may all be subscribed to by the same user as the user of the mobile endpoint device 108. For example, the user of the mobile endpoint device 108 may have an account and be registered with each one of the different social media applications 110, 112 and 114. The user may have different connections within each one of the social media applications 110, 112 and 114.

For example, the user may have connections that are only friends and family in the social media application 110, the user may have connections that are only professional acquaintances in the social media application 112 and the user may have connections that are only close friends in the social media application 114. As a result, if content (e.g., a picture, a video, a message, personal information of a contact, and the like) is uploaded or posted to the social media application 114, the user's connections in the social media applications 110 and 112 may not be able to view the content. Currently, if the user wanted to share the content with other users, the user would have to manually download the content on the social media application 114 and re-upload the content manually to the social media applications 110 and 112. With the large amount of content that is added daily to the social media applications 110, 112 and 114, this would become extremely cumbersome and tedious after many repetitions.

In one embodiment, a connection may be defined as another user of the social media applications 110, 112 and 114 that is associated with the user's social media applications 110, 112 and 114. For example, a connection may be “a friend,” “a follower,” “a circle member,” and the like.

One embodiment of the present disclosure provides a cloud service that creates an appearance that all of the user's accounts on the different social media applications 110, 112 and 114 are unified. As a result, content from any one of the social media applications 110, 112 and 114 may be downloaded and provided by the AS 104 of the cloud service. As a result, the content may be shared seamlessly across the different social media applications 110, 112 and 114 that were not previously possible.

In one embodiment, the mobile endpoint device 108 may be modified by configuring the mobile endpoint device 108 with a new content collection application or “app” that allows content to be downloaded automatically based upon a collection trigger. For example, the collection trigger may include a characteristic that initiates download of content that matches the characteristic. For example, the characteristic may be an emotional status (e.g., angry, happy, sad, and the like), a physical event (e.g., a birthday event, a wedding event, a graduation event, and the like), a location (e.g., an office building, a home location, a work location, a school, a particular city, a monument, a landmark, and the like) or a user preference (e.g., a periodic download (e.g., every day, every week, and the like), only content of a particular connection, only content of one of the social media applications 110, 112 and 114, and the like).

In one embodiment, the emotional status may be detected using one or more sensors on the mobile endpoint device 108. For example, a camera on the mobile endpoint device 108 may be used to analyze facial expressions of the user, the health monitors on the mobile endpoint device 108 may be used to detect a heart rate, a temperature sensor on the mobile endpoint device 108 may be used to detect a temperature of the user, and the like.

In one embodiment, the emotional status may be detected by analyzing the messages transmitted by the mobile endpoint device 108. For example, text messages may be analyzed to detect angry words, happy words, sad words, and the like. The text messages may be analyzed for emoticons (e.g., a happy face, an angry face, a sad face, and the like). In one embodiment, other messages may be analyzed, such as for example, emails, posts to one or more of the social media applications 110, 112 or 114, and the like.

In one embodiment, the physical event may be detected based upon a calendar application on the mobile endpoint device 108. In one embodiment, the location may be detected based upon a global positioning system (GPS) on the mobile endpoint device 108.

In one embodiment, when the user attempts to upload content to one of the social media applications 110, 112 or 114, the processor on the mobile endpoint device 108 may cause the content collection application to automatically open and prompt the user to tag the content that is being uploaded.

For example, the user may attempt to upload a wedding picture to the social media application 110. The mobile endpoint device 108 may detect the upload and cause the content collection application to open and prompt the user to tag the wedding picture. For example, the user may tag the wedding picture with one or more tags including an emotional status of happy, an event tag for a wedding and a location of Honolulu, Hawaii. As a result, when a collection trigger of happy is detected the mobile endpoint device 108 may collect the wedding picture from the social media application 110 to be sent to the cloud service AS 104 and to be provided to other connections in the social media applications 112 and 114.

In another embodiment, the content collection application may analyze the content on the social media applications 110, 112 and 114 to determine what characteristic is associated with the content. For example, a facial analysis function of the content collection application may analyze the expressions of the faces in a picture or video to determine the emotional status of the picture or video. In another embodiment, the content collection application may analyze a description associated with the content to determine the emotional status or the type of event. In one embodiment, the content may be geo-tagged and the content collection application may read the geo-tag to determine a location of the content. As a result, when a collection trigger is detected, the content application may analyze the content to collect content from the social media applications 110, 112 and 114 based on the collection trigger.

In one embodiment, when the collection trigger is detected by the mobile endpoint device 108, the mobile endpoint device 108 may log into or connect to each one of the social media applications 110, 112 and 114 simultaneously or in parallel. As a result, the mobile endpoint device 108 may be able to analyze the content and collect the content in accordance with the collection trigger from all of the social media applications 110, 112 and 114 in parallel or at the same time.

Once the content is collected by the mobile endpoint device 108, the content may be transmitted or sent to the AS 104 of the cloud service. The cloud service may provide a back up service for all of the content that is collected. In addition, the cloud service may virtualize all of the social media applications 110, 112 and 114 to appear as a unified social media application to the connections of the user in the different social media applications 110, 112 and 114.

For example, the mobile endpoint device 108 may send a social media content transfer request to the AS 104. In response, the AS 104 may authenticate the mobile endpoint device 108 (e.g., via a log-in and a password). If the mobile endpoint device 108 is authenticated, the AS 104 may establish a secure connection to the mobile endpoint device 108 and the mobile endpoint device 108 may send all of the collected content to the AS 104.

In one embodiment, the AS 104 may then generate an event book based on the content that is received. In one embodiment, the event book may be generated based on one or more user preferences. For example, the user preferences may include a chronological order, a grouping by different locations, a grouping by an emotional status, a grouping by an event, a grouping based on an author of the content, a grouping based on a particular one of the social media applications 110, 112 or 114 that the content was collected from, and the like.

In one embodiment, the content may be provided to one or more connections of each one of the plurality of different social media applications 110, 112 and 114. For example, the cloud service provider may connect with the user on each one of the social media applications 110, 112 and 114 as a connection. As a result, the cloud service provider may have access to the user's social media applications 110, 112 and 114 to post content that may be viewed by the user's other connections in the respective social media applications 110, 112 and 114.

When the content is ready to be provided, the AS 104 may log into the social media applications 110, 112 and 114 of the cloud service provider and then post the content onto the social media applications 110, 112 and 114 of the user. In one embodiment, the content may be posted as a link to the content that is stored in the DB 106 in the IP network 102.

In one embodiment, the user may define a group of connections with the AS 104 that may have access to the content via the link. In one embodiment, the access may be controlled by a password that may be sent to each connection of the group of connections. In one embodiment, the group of connections may include at least one connection from each one of the plurality of different social media applications 110, 112 and 114.

To illustrate, the mobile endpoint device 108 may detect a collection trigger having a characteristic of a happy emotional status. Thus, the mobile endpoint device 108 may cause the content collection application to collect happy content from the social media applications 110, 112 and 114. The happy content may be sent to the AS 104 and the AS 104 may generate an event book of the happy content that is organized based on a chronological order.

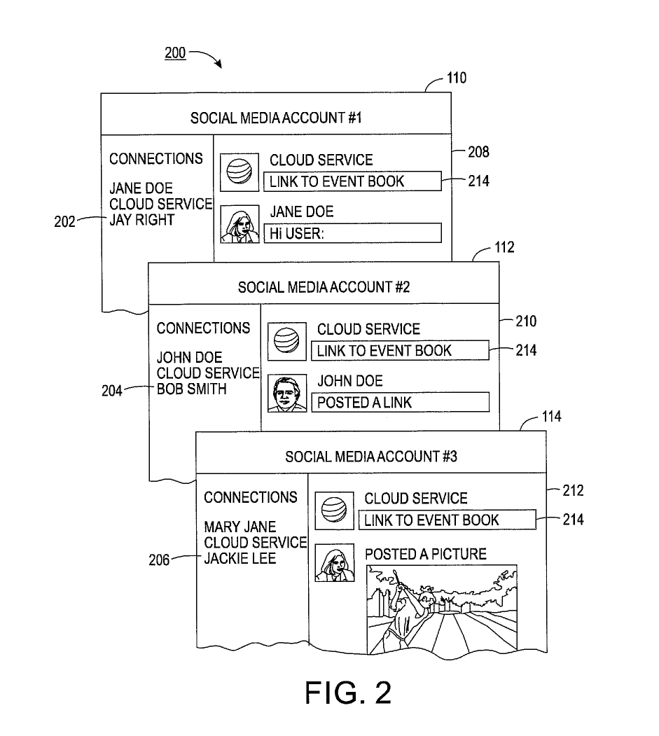

The AS 104 may log into the social media applications 110, 112 and 114 of the cloud service provider and find the user's page in the social media applications 110, 112 and 114, as shown in FIG. 2. For example, FIG. 2 illustrates the user interfaces of the social media applications 110, 112 and 114. Each one of the social media applications 110, 112 and 114 may show the user's connections 202, 204 and 206, respectively. Each one of the social media applications 110, 112 and 114 may also have a wall 208, 210 and 212, respectively where the user and the user's connections may post messages or upload content to the user's account. Notably, the “cloud service” has been added as a connection in each one of the social media applications 110, 112 and 114 of the user. The cloud service (e.g., the AS 104) may then post a link 214 on a wall of the user's account in each one of the social media applications 110, 112 and 114.

In one embodiment, the link 214 may be accessible by all of the connections 202, 204 and 206 of the user's accounts in the social media applications 110, 112 and 114. However, as noted above, the user may select a group of connections that may have access to the link 214. In other words, all of the connections 202, 204 and 206 may not have access to the link 214.

For example, only Jane Doe of the user's account in the social media application 110, only Bob Smith of the user's account in the social media application 112 and only Mary Jane of the user's account in the social media application 114 may have access to the link 214. In other words, although the link 214 is visible to all of the user's connections in each one of the social media applications 110, 112, and 114, only a group of connections defined by the user may have access to the link 214. For example, if Jay Right were to attempt to access the link 214 on the user's account of the social media application 110, the connection of Jay Right would be denied access to the link 214.

In another embodiment, the content may be provided to the group of connections directly. For example, the contact information for each connection of each one of the user's accounts in the social media applications 110, 112 and 114 may be stored at the DB 106 as part of the cloud service. The AS 104 may look up the contact information (e.g., an email address) associated with each connection in the group of connections and the content may be sent directly to each connection within the group of connections defined by the user.

Although the examples discussed above describe an embodiment where the mobile endpoint device 108 collects the content and then sends the content to the AS 104, in an alternate embodiment the content may be sent to the AS 104 directly from each one of the social media applications 110, 112 and 114. For example, the content that is identified to match the characteristic of the collection trigger by the content collection application on the mobile endpoint device 108 may be sent to the AS 104. For example, the content collection application may cause the user's account of the social media applications 110, 112 and 114 to “post” the content to the walls 208, 210 and 212 of the cloud service provider's account in the social media applications 110, 112 and 114, respectively. The AS 104 may then obtain the content from the walls 208, 210 and 212 of the cloud service provider's account of the social media applications 110, 112 and 114, respectively.

In another embodiment, the content may be sent back to the mobile endpoint device 108. The content may then be provided to the group of connections via the content collection application. For example, the content may be shared with other connections that also have the content collection application on his or her respective mobile endpoint device 108. Alternatively, the content collection application may directly send the content to each connection of the group of connections defined by the user via the contact information associated with each connection.

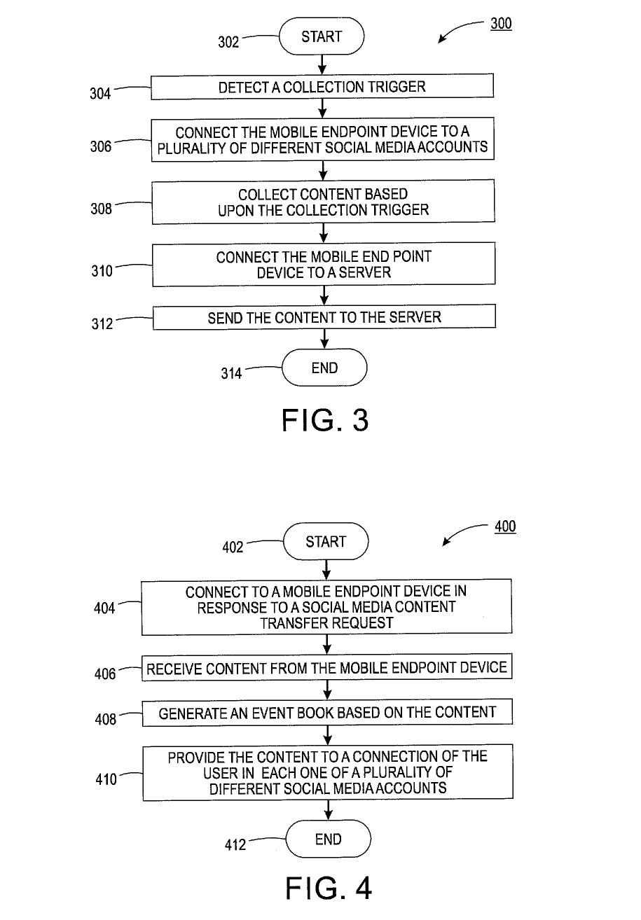

FIG. 3 illustrates a flowchart of an example method 300 for unifying a plurality of user accounts on different social media applications in accordance with the present disclosure. In one embodiment, steps, functions and/or operations of the method 300 may be performed by a mobile endpoint device 108. In one embodiment, the steps, functions, or operations of method 300 may be performed by a computing device or system 500, and/or processor 502 as described in connection with FIG. 5 below. For illustrative purpose, the method 300 is described in greater detail below in connection with an embodiment performed by a processor, such as processor 502.

The method 300 begins in step 302. At step 304, a processor detects a collection trigger. In one embodiment, the collection trigger may comprise a characteristic. For example, the characteristic may be an emotional status, a type of physical event, a location, a user preference, and the like. The processor may operate with one or more sensors on the mobile endpoint device to detect the emotional status of the user, the location of the user or the user preference. In one embodiment, the processor may analyze or interact with a calendar application on the mobile endpoint device to detect a type of physical event.

At step 306, the processor connects the mobile endpoint device to a plurality of different social media applications. For example, in response to the collection trigger, the processor may cause the mobile endpoint device to establish a connection with and log into each one of the plurality of different social media applications. In one embodiment, the mobile endpoint device may be connected to each one of the plurality of different social media applications in parallel or simultaneously.

At step 308, the processor collects content based upon the collection trigger. In one embodiment, the content may be collected from each one of the plurality of different social media applications. In one embodiment, the processor may analyze the content to identify one or more characteristics associated with the content to determine whether a characteristic of the content matches a characteristic of the collection trigger.

At step 310, the processor connects the mobile endpoint device to a server. In one embodiment, once the content collection is completed, the mobile endpoint device may send the server a social media content transfer request to establish a connection with the server. The mobile endpoint device may send authentication credentials (e.g., a log-in and a password) along with the request.

At step 312, the processor sends the content to the server. After the connection is established, the processor may send the content to the server such that the server may provide the content to a connection of the user in each one of the different social media applications. In other words, although the user has different connections in each one of the user's accounts in the plurality of different social media applications, the server may provide the content from one of the social media applications such that different connections in the other social media applications may also view or access the content.

In one embodiment, the server may generate an event book based on the content and the event book may be provided. In one embodiment, the content may be provided as a link that is posted to the wall of the user's account in each one of the plurality of different social media applications, wherein only a group of connections defined by the user may access the link. In another embodiment, the content may be provided directly to a group of connections defined by the user. At step 314, the method 300 ends.

FIG. 4 illustrates a flowchart of an example method 400 for unifying a plurality of user accounts on different social media applications in accordance with the present disclosure. In one embodiment, steps, functions and/or operations of the method 400 may be performed by a server 104. In one embodiment, the steps, functions, or operations of method 400 may be performed by a computing device or system 500, and/or processor 502 as described in connection with FIG. 5 below. For illustrative purpose, the method 400 is described in greater detail below in connection with an embodiment performed by a processor, such as processor 502.

The method 400 begins in step 402. At step 404, a processor connects to a mobile endpoint device in response to a social media content transfer request. For example, the processor may be part of a server that provides one or more cloud services to virtualize a plurality of different social media applications to appear as a unified or single social media application. As a result, the mobile endpoint device may collect content in response to a detected collection trigger and send the collected content to the server. The server may then store or back up the collected content or provide the collected content to other connections specified by a user of the mobile endpoint device on other social media applications.

At step 406, the processor receives content from the mobile endpoint device. For example, the content may be received directly from the mobile endpoint device. In another embodiment, the content may be received from the mobile endpoint device via the social media applications that the mobile endpoint device are connected to or logged into. For example, the mobile endpoint device may cause the social media application to post content to a wall of the cloud service provider on a cloud service provider's account of the social media application.

At optional step 408, the processor generates an event book based on the content. In one embodiment, the event book may be generated based on a user preference. For example, the user preferences may include a chronological order, a grouping by different locations, a grouping by an emotional status, a grouping by an event, a grouping based on an author of the content, a grouping based on the social media application that the content was collected from, and the like.

At step 410, the processor provides the content to a connection of the user in each one of a plurality of different social media applications. In one embodiment, the content may be provided as a link that is posted to the wall of the user's account in each one of the plurality of different social media applications, wherein only a group of connections defined by the user may access the link. In another embodiment, the content may be provided directly to a group of connections defined by the user. At step 412, the method 400 ends.

It should be noted that although not specifically specified, one or more steps, functions or operations of the methods 300 and 400 may include a storing, displaying and/or outputting step as required for a particular application. In other words, any data, records, fields, and/or intermediate results discussed in the respective methods can be stored, displayed and/or outputted to another device as required for a particular application. In addition, one or more steps, blocks, functions or operations of the above described methods 300 and 400 may comprise optional steps, or can be combined, separated, and/or performed in a different order from that described above, without departing from the example embodiments of the present disclosure.

As such, the present disclosure provides at least one advancement in the technical field of social media. This advancement allows for a system to unify a plurality of different social media applications of a user and allows content to be shared across different social media applications automatically with different connections associated with the different social media applications of the user. The present disclosure also provides a transformation of data. For example, a characteristic detected by a mobile endpoint device may be transformed into a collection trigger for the mobile endpoint device to collect content from the social media applications.

Finally, embodiments of the present disclosure improve the functioning of a computing device, e.g., a server and/or a user endpoint device. Namely, a server or a mobile endpoint device dedicated for unifying a plurality of different social media applications of a user is created or programmed that was not previously available.

FIG. 5 depicts a high-level block diagram of a computing device suitable for use in performing the functions described herein. As depicted in FIG. 5, the system 500 comprises one or more hardware processor elements 502 (e.g., a central processing unit (CPU), a microprocessor, or a multi-core processor), a memory 504 (e.g., random access memory (RAM) and/or read only memory (ROM)), a module 505 for unifying a plurality of user accounts on different social media applications, and various input/output devices 506 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computing device may employ a plurality of processor elements. Furthermore, although only one computing device is shown in the figure, if the methods 300 and 400, as discussed above, are implemented in a distributed or parallel manner for a particular illustrative example, i.e., the steps of the above methods 300 and 400, or the entirety of methods 300 and 400 are implemented across multiple or parallel computing device, then the computing device of this figure is intended to represent each of those multiple computing devices.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computing device or any other hardware equivalents, e.g., computer readable instructions pertaining to the method discussed above can be used to configure a hardware processor to perform the steps, functions and/or operations of the above disclosed methods 300 and 400. In one embodiment, instructions and data for the present module or process 505 for unifying a plurality of user accounts on different social media applications (e.g., a software program comprising computer-executable instructions) can be loaded into memory 504 and executed by hardware processor element 502 to implement the steps, functions or operations as discussed above in connection with the illustrative methods 300 and 400. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method can be perceived as a programmed processor or a specialized processor. As such, the present module 505 for unifying a plurality of user accounts on different social media applications (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not a limitation. Thus, the breadth and scope of a preferred embodiment should not be limited by any of the above-described exemplary embodiments, but should be defined only in accordance with the following claims and their equivalents.

What is claimed is:

1. A tangible computer-readable medium storing instructions which, when executed by a processor of a mobile endpoint device, cause the processor to perform operations, the operations comprising:
detecting a collection trigger;
connecting the mobile endpoint device to a plurality of different social media applications;
collecting a content from one of the plurality of different social media applications of a user based upon the collection trigger;
connecting the mobile endpoint device to a server that is located remotely from the mobile endpoint device; and
sending the content to the server, wherein the server is for providing the content to a connection of the user in at least one of the different social media applications.

2. The tangible computer-readable medium of claim 1, wherein the collection trigger comprises a characteristic.

3. The tangible computer-readable medium of claim 2, wherein the collecting the content comprises:
analyzing the content to match a characteristic of the content with the characteristic of the collection trigger.

4. The tangible computer-readable medium of claim 3, wherein the characteristic of the content is tagged via the mobile endpoint device when the content is uploaded to one of the plurality of different social media applications.

5. The tangible computer-readable medium of claim 2, wherein the characteristic comprises an emotional status.

6. The tangible computer-readable medium of claim 2, wherein the characteristic comprises a type of physical event.

7. The tangible computer-readable medium of claim 2, wherein the characteristic comprises a location.

8. The tangible computer-readable medium of claim 1, wherein the server is for providing the content as an event book that is organized in accordance with a user preference.

9. The tangible computer-readable medium of claim 1, wherein the content is provided as a link to the content located at the server that is posted to the each one of the different social media applications, wherein the link is accessible by a group of connections defined by the user via a password, wherein the group of connections comprises a different connection from the each one of the plurality of different social media applications.

10. A method, comprising:
detecting, by a processor of a mobile endpoint device, a collection trigger;
connecting, by the processor, the mobile endpoint device to a plurality of different social media applications;
collecting, by the processor, a content from one of the plurality of different social media applications of a user based upon the collection trigger;
connecting, by the processor, the mobile endpoint device to a server that is located remotely from the mobile endpoint device; and
sending, by the processor, the content to the server, wherein the server is for providing the content to a connection of the user in at least one of the different social media applications.

11. A method comprising:
connecting, by a processor, to a mobile endpoint device in response to a social media content transfer request;
receiving, by the processor, a content from the mobile endpoint device that was collected by the mobile endpoint device in response to a collection trigger from a plurality of different social media applications of a user based upon the collection trigger; and
providing, by the processor, the content to a connection of the user in at least one of the plurality of different social media applications.

12. The method of claim 11, wherein the content is provided as an event book that is organized in accordance with a user preference.

13. The method of claim 12, wherein the user preference comprises a chronological order.

14. The method of claim 11, further comprising:
joining, by the processor, each one of the plurality of different social media applications of the user as a new connection.

15. The method of claim 14, wherein the providing comprises:
connecting, by the processor, as the new connection to the each one of the plurality of different social media applications of the user; and
posting, by the processor, the content to at least one of the plurality of different social media applications of the user.

16. The method of claim 15, wherein the content is posted as a link.

17. The method of claim 16, wherein the link is accessible by a group of connections defined by the user via a password.

18. The method of claim 17, wherein the group of connections comprises a different connection from the each one of the plurality of different social media applications.

19. The method of claim 11, wherein the providing comprises:
identifying, by the processor, a contact information associated with the connection; and sending, by the processor, the content to the connection via the contact information.

20. The method of claim 11, wherein the providing comprises:
sending, by the processor, the content to an application on the mobile endpoint device, wherein the connection of the user in the at least one of the plurality of different social media applications accesses the content via the application on the mobile endpoint device.
